(19) United States
(12) Patent Application Publication
(10) Pub. No.: US 2015/0313255 A1
(43) Pub. Date: Nov. 5, 2015

(54) METHOD FOR MANUFACTURING A CHEWING GUM WITH IMPROVED HARDNESS BY IMPLEMENTING AN ANTI-CAKING AGENT AND CHEWING GUM THEREBY OBTAINED

(71) Applicant: ROQUETTE FRERES, Lestrem (FR)

(72) Inventors: Guillaume RIBADEAU-DUMAS, Lestrem (FR); Jose LIS, La Gorgue (FR); Dominique ORTIZ DE ZARATE, Merville (FR)

(21) Appl. No.: 14/651,865

(22) PCT Filed: Dec. 11, 2013
(86) PCT No.: PCT/FR2013/053032

§ 371 Date: Jun. 12, 2015

(30) Foreign Application Priority Data
Dec. 12, 2012 (FR) 12 61952

(51) Int. Cl. A23G 4/10; A23G 4/06

(52) U.S. Cl. CPC A23G 4/10; A23G 4/064; A23V 2002/00

(57) ABSTRACT

A method of using at least one anti-caking agent, preferably one with a specific surface area BET of at least 20 m²/g for manufacturing chewing gum compositions including at least sorbitol in powdered form as a sweetener. The hardness of chewing gums obtained from these compositions is increased, such an increase being desirable, for example to avoid deforming the centres to be coated in the coating turbines or to improve stick packaging speeds. The anti-caking agent is either introduced as an additive directly into the chewing gum, or mixed with the powdered sorbitol beforehand.

The present invention relates to the use of at least one anticaking agent, preferably exhibiting a BET specific surface of at least 20 m²/g, in the manufacture of chewing gum compositions comprising at least sorbitol in the powder form as sugaring agent. The hardness of the chewing gums obtained from these compositions is considerably enhanced. Such an enhancement is very advantageous during the manufacture of chewing gums and more particularly during the treatment of the chewing gum composition, for example in order to prevent the deformation of centers to be sugar coated in sugar-coating pans or in order to improve the throughputs for the wrapping of sticks (packaging). The anticaking agent is either introduced as direct additive into the chewing gum composition or mixed beforehand with a pulverulent sorbitol composition (premix).

Current chewing gum formulations, formulated with or without sugar, of or not of bubble-gum type, which are optionally sugar coated, comprise at least one non-hydrosoluble base gum, at least one sugaring agent in the powder or liquid form and at least one flavoring. They can also comprise, nonexhaustively, dyes, emulsifiers, plasticizers, intense sweeteners, food lubricants, pharmaceutical principles, water, and the like.

When they are produced without sugar, chewing gum compositions for the most part comprise sorbitol as sugaring agent. In liquid form, this nevertheless exhibits the disadvantage of easily crystallizing, which can result in a final composition which is particularly brittle, as taught in the document EP 1 741 344. Its solid version, in the form of a pulverulent product, will thus be preferred to it, such as in particular recommended in the document EP 0 664 960.

Conventionally and as indicated, for example, in the document “Chewing gum sans sucre à base de maltitol” [Maltitol-based sugar-free chewing gum] (Maruyama T., Terasawa M. and Takiguchi T., Shokuhin Kôgyô, 1984, 27, No. 24, pp. 73-80), the chewing gum composition is produced by mixing the various constituents under hot conditions in a Z-arm mixer with a jacket generally maintained between 45° C. and 80° C. Said composition is subsequently shaped by extrusion, rolling, cutting or cooling and then the resulting chewing gum is packaged and transported to a place of sale, waiting to be consumed. It should be noted that several days, indeed even several weeks, may elapse between the manufacture of the chewing gum and its date of consumption.

It is important for the chewing gum composition or the chewing gum obtained from this composition to exhibit the highest possible hardness throughout the storage period but also throughout the process for the manufacture of the chewing gum (in particular in order to prevent deformations in the sugar-coating pans or in order to optimize the rates of packaging of sticks).

The hardness is a mechanical characteristic well known to a person skilled in the art which can be easily grasped through a test of the same name, employing a device referred to as penetrometer or texture analyzer. The principle of the experiment consists in measuring the resistance which a face of a sample puts forward to the penetration of a harder body, such as a point or a ball.

Generally, an attempt would be made to increase the hardness of chewing gum compositions or of chewing gums if it is desired to use a base gum giving a very flexible/soft chew, if it is desired to introduce a great deal of liquid flavoring into the chewing gum or also if an attempt is made to introduce a large amount of liquid phase (for example glycerol or maltitol syrup Lycasin® 85/55, sold by the applicant company), in order to reduce the manufacturing cost.

A means well known to a person skilled in the art for adjusting the hardness of the chewing gum composition or of the chewing gum is to vary the amount of glycerol which the composition comprises and/or the ratio between sugaring agent introduced in the liquid form and in the powder form; this is reported in particular in the document WO 2011/109376. In point of fact, these techniques by nature result in significant modifications to the recipe of the composition, with regard to the amounts of products involved; such modifications are not necessarily desired by the formulator.

Consequently, there exists a major need to have available a process for the manufacture of a chewing gum composition comprising sorbitol in the powder form which is simultaneously simple to carry out, which does not result in major modifications with regard to the amounts of products conventionally involved and which results in a chewing gum having an improved hardness retained over time.

While working in this direction, the applicant company has succeeded in developing such a process. The latter is based in particular on the introduction of an anticaking agent into the chewing gum composition, said agent being introduced as direct additive into the chewing gum composition (that is to say, mixed with the other ingredients) or being introduced in combination with the pulverulent sorbitol composition (that is to say, mixed beforehand with the sorbitol in the powder form).

Thus, the subject matter of the invention is the use of at least one anticaking agent, preferably of just one anticaking agent, in a chewing gum composition comprising sorbitol in the powder form for increasing the hardness of the chewing gum obtained from said chewing gum composition.

In other words, the present invention consists of a process for improving the hardness of a chewing gum obtained from a chewing gum composition comprising sorbitol in the powder form which consists in using at least one anticaking agent, preferably just one anticaking agent, in said chewing gum composition.

The expressions “pulverulent sorbitol composition” or “sorbitol in the powder form” both denote, within the meaning of the present patent application, a composition comprising sorbitol, characterized in that it exhibits a dry matter content of at least 97%, preferably at least 98%, very preferably at least 98.5%, of its total weight (pulverulent nature), said dry matter being represented to more than 85% by weight, preferably to more than 90% by weight, very preferably to more than 91% by weight, of sorbitol (sorbitol composition).

The term “anticaking” denotes the ability of a compound to prevent/reduce the problems of caking of a powder, that is to say the phenomenon of agglomeration of the individual particles making up said powder, such a phenomenon being related in particular to the presence of moisture.

Very unexpectedly, the use of at least one anticaking agent results in a chewing gum, the hardness of which is greatly increased with respect to that of a chewing gum resulting from the same process but without employing an anticaking agent. Preferably, just one anticaking agent is used.

This hardness is measured during the process for the manufacture of the chewing gum but also during the storage period.

The document US 2003/0086999 discloses the use of silica gel for preserving the formulation of chewing gum in the form of free particles and rendering this formulation nonsticky.

The document EP 0 275 706 relates to an oral composition and more particularly a toothpaste based on silica and PEG which exhibits good “preservation” of shape and good extrudability.

The document EP 1 481 593 teaches a specific formulation for the manufacture of a chewing gum tablet which does not disintegrate or crumble or break up during the first chewing actions. A flow agent is mentioned as optional.

The document WO 01/47368 is targeted at a degradable chewing gum.

The document WO94/16576 relates to a chewing gum with taste, with intense flavoring and with a duration which is prolonged by virtue of the use of finely divided silica to adsorb said flavoring.

The document WO 00/08944 is targeted at chewing gums which do not stick.

None of these documents discloses the use of at least one anticaking agent, preferably of one anticaking agent, in a chewing gum composition comprising sorbitol in the powder form for improving the hardness of this composition and consequently that of the final chewing gum.

It is the same for the paper “Medicated chewing gum, a potential drug delivery system” by Chaudhary and Shahiwala (Expert Opinion on Drug Delivery, vol. 7, No. 7, July 2010, pages 871-885).

Mention may be made, among the anticaking agents recommended by the applicant company, without implied limitation, of silicas and preferably fumed, colloidal, precipitated, micronized and amorphous silicas, silicon oxides, sodium aluminum silicates, talc, calcium carbonate, manganese oxide, tricalcium phosphate, dehydrated potato starch (and preferably potato starch dehydrated to less than 12% by weight, preferably less than 8% by weight, preferably to 6% by weight, of residual water), sodium ferrocyanide, potassium ferrocyanide and iron hexacyanomanganate.

Preferably, the anticaking agent exhibits a BET specific surface of at least 20 m²/g, preferably of at least 100 m²/g, very preferably of at least 200 m²/g. Preferably, the anticaking agent exhibits a BET specific surface of at most 1000 m²/g and more preferably of at most 500 m²/g.

In the present patent application, the BET specific surface is measured using a Beckman-Coulter SA3100 device.

More preferably, the anticaking agent is chosen from fumed, colloidal, precipitated and amorphous silicas and more preferably from those which exhibit a BET specific surface of at least 20 m²/g, preferably of at least 100 m²/g, very preferably of at least 250 m²/g.

More preferably still, the anticaking agent is a micronized silica with a BET specific surface of the order of 250 m²/g.

Throughout the continuation of the patent application, the expression “compound exhibiting a high BET specific surface” may be used in place of “compound exhibiting a BET specific surface of at least 20 m²/g, preferably of at least 100 m²/g, very preferably of at least 200 m²/g”.

The amount of anticaking agent used is from 0.1% to 20% by dry weight, preferably from 0.1% to 5% by dry weight, with respect to the dry weight of sorbitol.

More particularly, the chewing gum composition according to the present invention comprises:
from 5% to 95%, preferably from 20% to 50%, of at least one base gum,
from 1% to 95%, preferably from 10% to 60%, of a pulverulent sorbitol composition,
from 0.1% to 10%, preferably from 0.1% to 3%, of at least one flavoring,
   these percentages being indicated by dry weight with respect to the total weight of the composition, and
from 0.1% to 20%, preferably from 0.1% to 5%, of at least one anticaking agent, this percentage being expressed by dry weight with respect to the dry weight of sorbitol.

The base gum used is chosen as a function of the type of chewing gum which it is desired to manufacture. It can be chosen from synthetic and/or natural elastomers, such as polyisoprene, polyvinyl acetate, polyisobutylene, latexes, resins, such as terpene resins, polyvinyl esters and alcohols, fatty substances or waxes, such as, for example, lanolin, partially or non-partially hydrogenated vegetable oils, fatty acids, glycerol partial esters, paraffin wax or microcrystalline waxes.

The sorbitol in the powder form used preferably exhibits a BET specific surface of between 0.1 m²/g and 10 m²/g.

The chewing gum composition may also comprise another polyol such as sorbitol as sugaring agent, in the powder or liquid form, such as, for example, mannitol, maltitol, xylitol, erythritol, lactitol, isomalt, maltitol syrups, sorbitol syrups or hydrogenated glucose syrups. Said polyol is then present in a proportion of at most 20% by dry weight, with respect to the total weight of the composition.

The chewing gum composition can additionally comprise, in a proportion of at most 5% by weight with respect to the total weight of the composition, at least one constituent chosen from colorants, intense sweeteners, such as aspartame, acesulfame-K, alitame, neotame, sucralose, saccharin, neohesperidin DC, steviosides, brazzein, and the like, pharmaceutical active principles, minerals, plant extracts, antioxidants, indigestible fibers, such as, for example, oligosaccharides, such as fructo-oligosaccharides, indigestible fibers, such as Fibersol™, sold by Matsutani, or Nutriose™ FB, sold by the applicant company, emulsifiers, such as lecithin, and the like.

In a first alternative form, the anticaking agent is introduced directly into the composition, as a mixture with at least the base gum, the flavoring and the pulverulent sorbitol composition and optionally other compounds as explained above.

In a second alternative form, the anticaking agent is introduced by prior mixing with the pulverulent sorbitol composition, before being mixed with at least the base gum and the flavoring and optionally other compounds as explained above. In this case, the anticaking agent/pulverulent sorbitol prior mixture is produced according to any one of the processes for mixing powders which are well known to a person skilled in the art (in particular in batch or continuous form). Mention may in particular be made, as batch mixers which can be used, of the mixers sold by Turbula, Lodige, Forberg and Gericke; mention may be made, as regards the continuous mixers, of the devices sold by Lodige, Forberg and Gericke.

In other words, the anticaking agent is introduced to the base gum separately from the pulverulent sorbitol composition or is introduced to the base gum in the form of a premix with the pulverulent sorbitol composition.

As indicated above, the chewing gum composition of use according to the present invention is that resulting from the mixing of at least one base gum, one pulverulent sorbitol composition, one flavoring and one anticaking agent. Said composition or said mixture is subsequently subjected to extrusion, rolling, cutting, cooling and then conditioning operations which result in the final chewing gum. The conditioning can comprise in particular sugar-coating stages.

The stage of mixing the various abovementioned compounds or constituents is very obviously separate from the stage of mixing the anticaking agent and the pulverulent sorbitol composition, according to the second alternative form of the use, which is a subject matter of the present invention, where the anticaking agent is not used as direct additive but is delivered via the pulverulent sorbitol within the chewing gum composition.

The process for the preparation of the chewing gum composition used in the present invention thus comprises at least one stage of mixing at least:
the gum, the pulverulent sorbitol composition, the flavoring and the anticaking agent in a first alternative form, or
the gum, the pulverulent composition, additivated beforehand with the anticaking agent, and the flavoring, according to a second alternative form.

This mixing of the various constituents of the chewing gum composition is carried out under hot conditions at a temperature of between 45° C. and 80° C., preferably in a Z-arm mixer with a jacket. Preferably, it is advisable, before the introduction of other constituents, to heat the base gum to a temperature of between 45° C. and 80° C., preferably between 45° C. and 55° C., by any means known to a person skilled in the art. It is possible, by way of example, to heat it in a microwave oven or in an oven. The stages of extrusion, rolling, cutting, cooling and then conditioning which result in the chewing gum are carried out according to any one of the techniques well known to a person skilled in the art. Reference may be made to the experimental part illustrating the present patent application but also to the abovementioned document “Chewing gum sans sucre à base de maltitol” [Maltitol-based sugar-free chewing gum]. In the end, the chewing gum is present in one of the forms well known to a person skilled in the art, such as sticks, balls, sugar-coated pills, cubes or tablets.

A better understanding of the invention will be obtained on reading the following examples, which cannot in any way limit the present invention.

In particular, these examples demonstrate all the advantages of using an anticaking agent in particular with a BET specific surface of at least 20 m²/g, preferably of at least 100 m²/g, very preferably of at least 200 m²/g.

Another subject matter of the present invention is a pulverulent sorbitol composition comprising at least one anticaking agent.

More particularly, another subject matter of the present invention is a pulverulent sorbitol composition comprising from 0.1% to 20%, preferably from 0.1% to 5%, of at least one anticaking agent, the percentages being expressed by dry weight with respect to the dry weight of sorbitol.

Preferably, the pulverulent sorbitol composition according to the invention comprises just one anticaking agent (in other words, just one type of anticaking agent).

The pulverulent composition is the same as that mentioned above. Likewise, the agent or agents are chosen from the same agents as those mentioned above.

Thus, the anticaking agent is chosen in particular from silicas and preferably fumed, colloidal, precipitated, micronized and amorphous silicas, silicon oxides, sodium aluminum silicates, talc, calcium carbonate, magnesium oxide, tricalcium phosphate, dehydrated potato starch (and preferably the potato starch dehydrated to less than 12% by weight, preferably less than 8% by weight, preferably to 6% by weight of residual water), sodium ferrocyanide, potassium ferrocyanide and iron hexacyanomanganate.

The anticaking agent is advantageously chosen from fumed, colloidal, precipitated, micronized and amorphous silicas.

Preferably, the anticaking agent additionally exhibits a BET specific surface of at least 20 m²/g, preferably of at least 100 m²/g, very preferably of at least 200 m²/g, and of at most 1000 m²/g and more preferably of at most 500 m²/g.

More preferably, the anticaking agent is chosen from micronized silicas exhibiting a BET specific surface of at least 200 m²/g and of at most 500 m²/g.

### EXAMPLES

In the examples below, the hardness is measured on a texture analyzer (Instron) provided with a cylindrical punch, the rate of penetration of which is adjusted to 50 mm/minute. The hardness corresponds to the maximum force observed while the punch passes completely through the sample (rectangular parallelepiped: 30×17×5 mm).

As indicated above, in the present patent application, the BET specific surface is measured using a Beckman-Coulter SA3100 device.

In the case of the sorbitol, the method consists initially in sieving a sufficient amount of sample over sieves making it possible to recover approximately 3 grams of a particle size fraction of between 841 and 250 microns. In the case of the anticaking agents, this sieving stage does not exist.

A sample is introduced into a measurement cell dried beforehand and tared to within about 0.001 g, the sample being sufficient to ¾ fill the reservoir of the cell. The cell is then placed at the degassing station. Degassing having been carried out, the cell is reweighed to within about 0.001 g and placed at the measurement station. The specific surface is expressed in m²/g.

### Example 1

### Hardness During the Stage of Cooling the Chewing Gum

Different chewing gum compositions comprising sorbitol in the powder form, optionally as a mixture with an anticaking agent, in the case in point a silica, were prepared.

For each of the chewing gums obtained from these compositions, the change in their hardness during the cooling stage, after the stage of mixing the various constituents under hot conditions, and the rolling stage was monitored.

Seven different chewing gum compositions were prepared according to a first recipe (cf. table 1).

The “standard” composition was composed of: (the amounts being expressed as % by dry weight with respect to the total weight of the composition):

| | |
|---|---|
| Base gum, Optima ® (Cafosa): | 34.00% |
| Pulverulent sorbitol composition: | 50.55% |
| Glycerol: | 4.00% |
| Maltitol syrup, Lycasin ® 85/55: | 9.00% |
| Mint flavoring (liquid): | 1.80% |
| Mint flavoring (powder): | 0.30% |
| Intense sweetener: | 0.35% |

The protocol for preparing the chewing gum was as follows:
The base gum is heated in a microwave oven and introduced into the mixer.
Half of the pulverulent sorbitol composition is added and mixing is carried out for 3 minutes.
The maltitol syrup Lycasin® 85/55 is added and mixing is carried out for 2 minutes.
The second half of the pulverulent sorbitol composition, the liquid flavoring and the intense sweeteners are added and mixing is carried out for 3 minutes.
The glycerol is added and mixing is carried out for 2 minutes.
The liquid flavoring is added and mixing is carried out for 2 minutes.
The product is discharged from the mixer, shaped and rolled to a thickness of 5 mm.

In the case where the chewing gum composition additionally comprised an anticaking agent (in accordance with the present invention), in the case in point a silica having a high BET specific surface, the anticaking agent was introduced with the pulverulent sorbitol composition. More specifically, the anticaking agent was mixed at ambient temperature with stirring for approximately 5 minutes with the pulverulent sorbitol composition before the latter was added to the base gum (premixing, alternative form 2 of the present invention).

The Neosorb® P60W and the Neosorb® P 60A used are sorbitols in the powder form sold by the applicant company.

The Tixosil® 331 is a micronized silica sold by Rhodia, with a BET specific surface of the order of 250 m²/g.

TABLE 1

| | | | Hardness | Hardness | Hardness |
|---|---|---|---|---|---|
| | | Tixosil ® | 45° C. | 35° C. | 20° C. |
| Composition | Sorbitol | 331 | (N) | (N) | (N) |
| 1 | Neosorb P | 0 | 3.6 | 7.4 | 21.7 |
| | 60W | | | | |
| 2 | Neosorb P | 0.2% | 4.3 | 11.1 | 27.1 |
| | 60W | | | | |
| 3 | Neosorb P | 0.5% | 5 | 11.7 | 30.5 |
| | 60W | | | | |
| 4 | Neosorb P | 1.0% | 5.1 | 11.4 | 31.5 |
| | 60W | | | | |
| 5 | Neosorb P | 0 | 2.4 | 5.1 | 16.1 |
| | 60A | | | | |
| 6 | Neosorb P | 0.5% | 3.8 | 8.4 | 22.5 |
| | 60A | | | | |
| 7 | Neosorb P | 1.0% | 4.7 | 8.4 | 25.6 |
| | 60A | | | | |

(the % indicated correspond to the % by dry weight of silica used with respect to the dry weight of sorbitol)

These results clearly show the positive influence for a type of sorbitol powder of the use for an anticaking agent, in the case in point of a silica exhibiting a BET specific surface of the order of 250 m²/g, on the hardness of the chewing gum, the final product, during the process of cooling the chewing gum composition.

Seven other chewing gum compositions were prepared according to a second recipe (cf. table 2).

The second type of composition was composed of:

| | |
|---|---|
| Base gum, Velvet ®: | 34.00% |
| Pulverulent sorbitol composition: | 35.00% |
| Mannitol 35: | 12.00% |
| Xylitol, Xylisorb ® 90: | 10.00% |
| Glycerol: | 5.50% |
| Mint/vanilla flavoring (liquid): | 1.00% |
| Mint/vanilla flavoring (powder): | 2.00% |
| Intense sweetener: | 0.35% |
| Lecithin: | 0.15% |

(% expressed by dry weight of each of its constituents with respect to its total weight)

The chewing gum was produced according to the following protocol:
The base gum is heated in a microwave oven and introduced into the mixer.
Half of the pulverulent sorbitol composition and the lecithin are added and mixing is carried out for 2 minutes.
The glycerol is added and mixing is carried out for 2 minutes.
The mannitol and the xylitol are added and mixing is carried out for 2 minutes.
The second half of the pulverulent sorbitol composition is added and mixing is carried out for 2 minutes.
The powder flavoring and the intense sweeteners are added and mixing is carried out for 1 minute.
The liquid flavoring is added and mixing is carried out for 1 minute.
The product is discharged from the mixer, shaped and rolled to a thickness of 5 mm.

In the case where the chewing gum composition comprised an anticaking agent, in the case in point a silica, tricalcium phosphate or a magnesium stearate, the anticaking agent was introduced with the pulverulent sorbitol composition.

More specifically, the anticaking agent was mixed at ambient temperature with the pulverulent sorbitol composition before the latter was added to the base gum (premixing, alternative form 2 of the present invention).

Anticaking agents used:

Silica Tixosil® 331 with a BET specific surface of approximately 250 m²/g.

Tricalcium phosphate (Budenheim) with a BET specific surface equal to 1.30 m²/g,

Magnesium stearate (Baerlocher) with a BET specific surface equal to 2.4 m²/g.

The % indicated in table 2 below correspond to the % by dry weight of anticaking agent used with respect to the dry weight of sorbitol.

TABLE 2

| | | | | Tri- | Hardness | Hardness | Hardness |
|---|---|---|---|---|---|---|---|
| | | Tixosil ® | Magnesium | calcium | 45° C. | 35° C. | 20° C. |
| Composition | Sorbitol | 331 | stearate | phosphate | (N) | (N) | (N) |
| 8 | Neosorb P | 0 | 0 | 0 | 1.5 | 3.1 | 8.6 |
| | 60A | | | | | | |
| 9 | Neosorb P | 0.2% | 0 | 0 | 1.7 | 3.7 | 11.1 |
| | 60A | | | | | | |
| 10 | Neosorb P | 0.5% | 0 | 0 | 2.2 | 4.6 | 13.9 |
| | 60A | | | | | | |
| 11 | Neosorb P | 0 | 0 | 0 | 2 | 3.8 | 12.3 |
| | 60W | | | | | | |
| 12 | Neosorb P | 1.0% | 0 | 0 | 2.1 | 4.5 | 13 |
| | 60W | | | | | | |
| 13 | Neosorb P | 0 | 0.5% | 0 | 2.3 | 3.7 | 10.9 |
| | 60A | | | | | | |
| 14 | Neosorb P | 0 | 0 | 0.5% | 2.4 | 3.7 | 10.8 |
| | 60A | | | | | | |

These results clearly show the positive influence for a given type of sorbitol of the use for an anticaking agent on the hardness of the final product, during the cooling process.

The hardness is in particular considerably increased in the case where the silica Tixosil® 331 is used as anticaking agent.

### Example 2

### Hardness as a Function of the Time

In this example, the preceding compositions 1 to 12 were taken again and their hardnesses were monitored over time, at the moments t=1, 8 and 15 days, at ambient temperature. The results obtained appear in tables 3 and 4.

TABLE 3

| | | | Hardness | Hardness | Hardness |
|---|---|---|---|---|---|
| | | Tixosil ® | 1 d | 8 d | 15 d |
| Composition | Sorbitol | 331 | (N) | (N) | (N) |
| 1 | Neosorb P | 0 | 28.6 | 32.3 | 33.1 |
| | 60W | | | | |
| 2 | Neosorb P | 0.2% | 34.7 | 43.1 | 41 |
| | 60W | | | | |
| 3 | Neosorb P | 0.5% | 32.4 | 39.3 | 43.6 |
| | 60W | | | | |
| 4 | Neosorb P | 1.0% | 37.7 | 45.9 | 45.7 |
| | 60W | | | | |
| 5 | Neosorb P | 0 | 21.8 | 31.4 | 28.9 |
| | 60A | | | | |
| 6 | Neosorb P | 0.5% | 32.4 | 35.2 | 36.5 |
| | 60A | | | | |
| 7 | Neosorb P | 1.0% | 33.2 | 39.4 | 40.6 |
| | 60A | | | | |

TABLE 4

| | | | Hard- | Hard- | Hard- |
|---|---|---|---|---|---|
| | | | ness | ness | ness |
| Compos- | | Tixosil | 1 d | 8 d | 15 d |
| ition | Sorbitol | ® 331 | (N) | (N) | (N) |
| 8 | Neosorb P | 0 | 14.2 | 19.3 | 17 |
| | 60A | | | | |
| 9 | Neosorb P | 0.2% | 15.9 | 20.4 | 19.7 |
| | 60A | | | | |
| 10 | Neosorb P | 0.5% | 18.2 | 22.6 | 20.5 |
| | 60A | | | | |
| 11 | Neosorb P | 0 | 16.7 | 21.1 | 20.7 |
| | 60W | | | | |
| 12 | Neosorb P | 1.0% | 19.9 | 22.8 | 22.9 |
| | 60W | | | | |

These results clearly show that the reinforcing of the hardness continues or is retained with the passage of time for the compositions according to the invention.

1-13. (canceled)

14. A process for improving the hardness of a chewing gum obtained from a chewing gum composition comprising sorbitol in the powder form which comprises using an effective amount of at least one anticaking agent in said chewing gum composition.

15. The process as claimed in claim 14, wherein the anticaking agent is chosen from silicas and preferably fumed, colloidal, precipitated, micronized and amorphous silicas, silicon oxides, sodium aluminum silicates, talc, calcium carbonate, manganese oxide, tricalcium phosphate, dehydrated potato starch, sodium ferrocyanide, potassium ferrocyanide and iron hexacyanomanganate.

16. The process as claimed in claim 14, wherein the anticaking agent exhibits a BET specific surface of at least 20 m²/g, preferably of at least 100 m²/g, very preferably of at least 200 m²/g.

17. The process as claimed in claim 14, wherein the anticaking agent is chosen from fumed, colloidal, precipitated and amorphous silicas and more preferably from those which exhibit a BET specific surface of at least 20 m²/g, preferably of at least 100 m²/g, very preferably of at least 200 m²/g.

18. The process as claimed in claim 14, wherein the anticaking agent is a micronized silica with a BET specific surface of the order of 250 m²/g.

19. The process as claimed in claim 14, wherein the chewing gum composition comprises from:
5% to 95%, preferably 20% to 50%, of at least one base gum,
1% to 95%, preferably 10% to 60%, of a pulverulent sorbitol composition,
0.1% to 10%, preferably 0.1% to 3%, of at least one flavoring,
the percentages being indicated by dry weight with respect to the total weight of said chewing gum composition, and
0.1% to 20%, preferably 0.1% to 5%, by dry weight of at least one anticaking agent with respect to the dry weight of sorbitol.

20. The process as claimed in claim 14, wherein the anticaking agent is introduced to the base gum separately from the pulverulent sorbitol composition.

21. The process as claimed in claim 14, wherein the anticaking agent is introduced to the base gum in the form of a premix with the pulverulent sorbitol composition.

22. The process as claimed in claim 14, wherein the sorbitol used exhibits a BET specific surface of between 0.1 m²/g and 10 m²/g.

23. A pulverulent sorbitol composition comprising from 0.1% to 20%, preferably from 0.1% to 5%, of at least one anticaking agent, the percentages being expressed by dry weight with respect to the dry weight of sorbitol.

24. The composition as claimed in claim 23, wherein the anticaking agent is chosen from fumed, colloidal, precipitated, micronized and amorphous silicas.

25. The composition as claimed in claim 24, wherein the anticaking agent additionally exhibits a BET specific surface of at least 20 m²/g and of at most 1000 m²/g.

26. The composition as claimed in claim 23, wherein the anticaking agent is chosen from micronized silicas exhibiting a BET specific surface of at least 200 m²/g and of at most 500 m²/g.
